(19) United States
(12) Patent Application Publication
(10) Pub. No.: US 2026/0087186 A1
(43) Pub. Date: Mar. 26, 2026

(54) Adaption Method of 3D Modeling Parametric software

(71) Applicant: Vyacheslav Rudchenko, Red Deer (CA)

(72) Inventor: Vyacheslav Rudchenko, Red Deer (CA)

(21) Appl. No.: 19/079,681

(22) Filed: Mar. 14, 2025

(51) Int. Cl. G06F 30/12; G06F 30/17; G06F 111/10

(52) U.S. Cl. CPC G06F 30/12; G06F 30/17; G06F 2111/10

(57) ABSTRACT

Method to develop 3D parametric model by anybody, with minimum or none of 3D modeling experience, as gamers and other users, to the product.

By implementing new adapter-application to simplify existing 3D parametric software (such as: Siemens NX, Creo, SolidWorks and similar programs), an increment of the users capable to utilize 3D parametric software will be achieved.

The patent could be described as 3D parametric software adapter-application, as existing 3D parametric software are built to be simple to use and modified for customers, but doesn't exist programs, what do transition/adaption between most efficient as a result complex and required training in 3D parametric programs and untrained users.

### BACKGROUND OF THE INVENTION

To achieve utilization of listed parametric software by any user, between Siemens NX, Creo, SW and similar programs-to end users, who has minimum or none of 3D modeling experience, is required to develop “transition software/adapter-application” with friendly to end users interface supported by listed above 3D parametric software. This transition software needs to have simple tools and navigation system, similar to gaming, allow to operate listed above complex software, without go through training, to allow anybody develop 3D model and further product.

Described above application will allow to achieve developer and user's goals:

Developer's related:
a) Expose for modification only selected 3D product parameters.
b) Allow to perform modifications by any user, due to achieved simplicity in usage, by narrowing types and quantity of tools used for modifications to required minimum, and simplifying user's controlling tools interface.
c) Allow to produce modifications supported by users / customers.

User's related:
d) Allow to avoid required software training, to be able utilize and perform modifications in 3D parametric software.

Alternative, further product development:
e) Ability for supply-production network connection,
f) Ability to manage certification and production of 3D parametric developed product.

### SUMMARY OF THE INVENTION

Such adapter software/applications can be integrated within current (listed above) 3D parametric programs, by having customized, generated for selected 3D model/file, Transition Graphic frame (utilizing 3D model's graphic elements), under to be developed program—application, have adjustable in type and number, simple to operate and available for selection tools, out of all range currently available in 3D parametric software, with Function of Controlling of all selected dependable 3D parametric original parameters on parts and assembly levels, to perform defined 3D model modifications. Such graphic's frame application, should maintain interface principle from complex (original parametric software features, parameters) to simple (similar to gaming, adapted to any user, 3D model controlling and navigation tools).

In the drawings, which form a part of this specification,

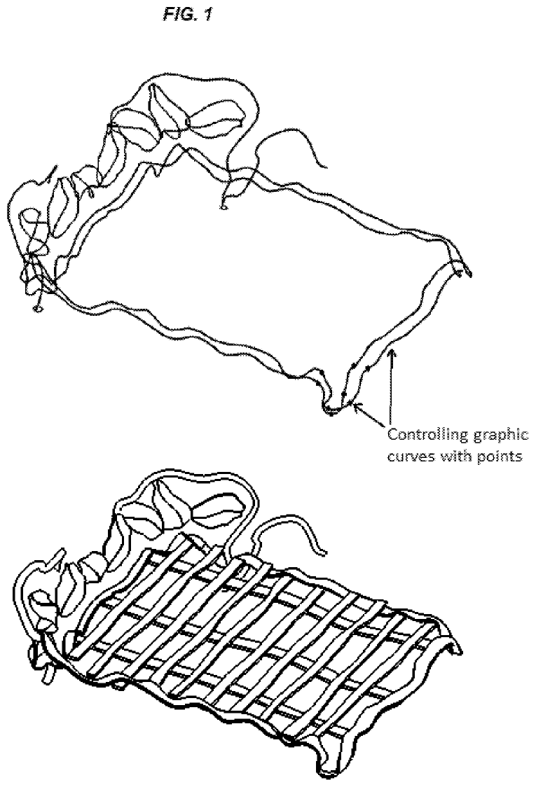

FIG. 1. Example of the Transition Graphic frame generated for end users to perform modifications for customized 3D model of the bed, through introduced graphic elements, such as: controlling points and curves, corresponded to 3D model components of the bed.

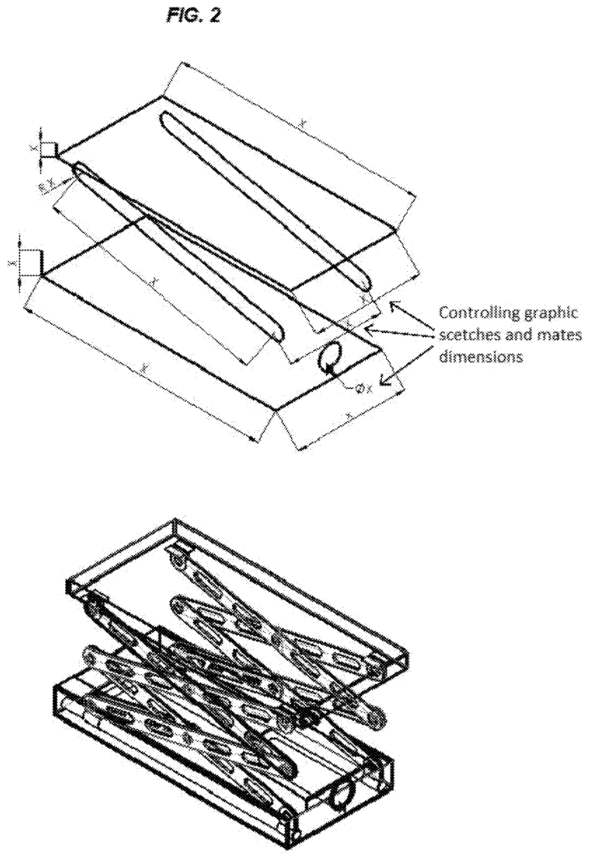

FIG. 2. Example of the Transition Graphic frame generated for end users to perform modifications for customized 3D model of the scissors lifting mechanism, through introduced graphic elements, such as: scetch's controlling dimensions, corresponded to 3D model components and mates of the mechanism.

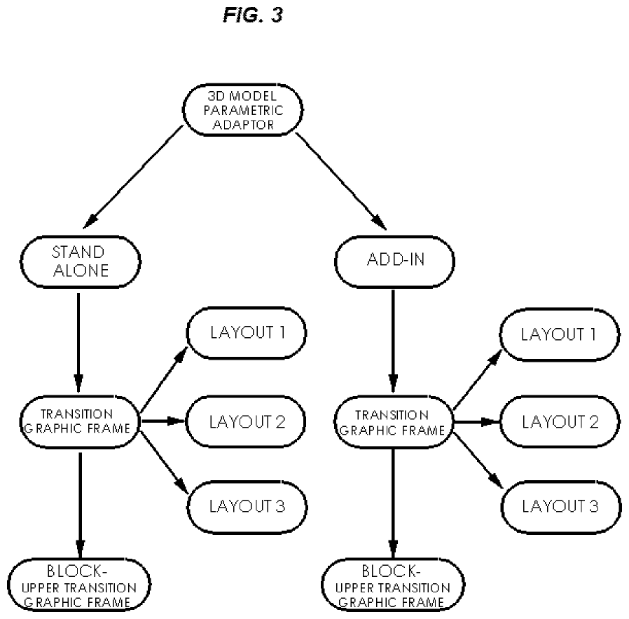

FIG. 3. Adapter application structure.

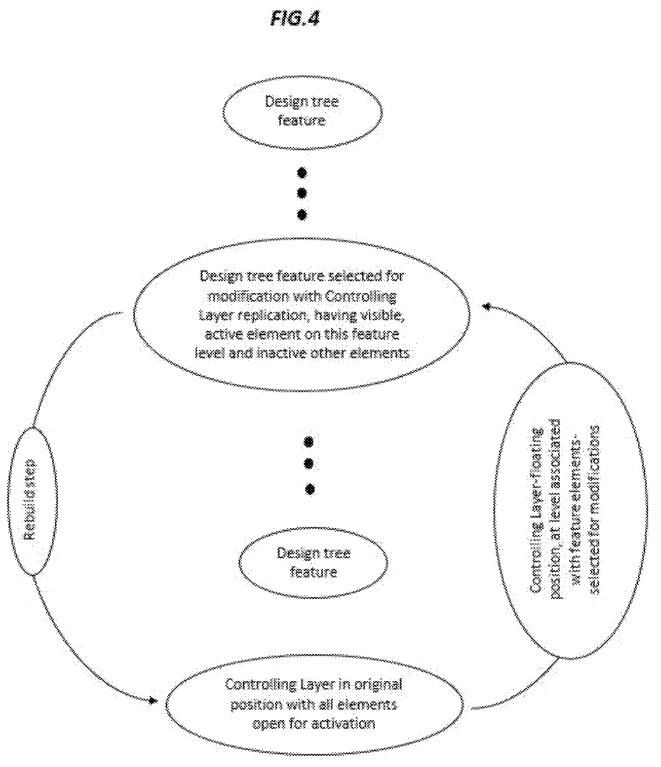

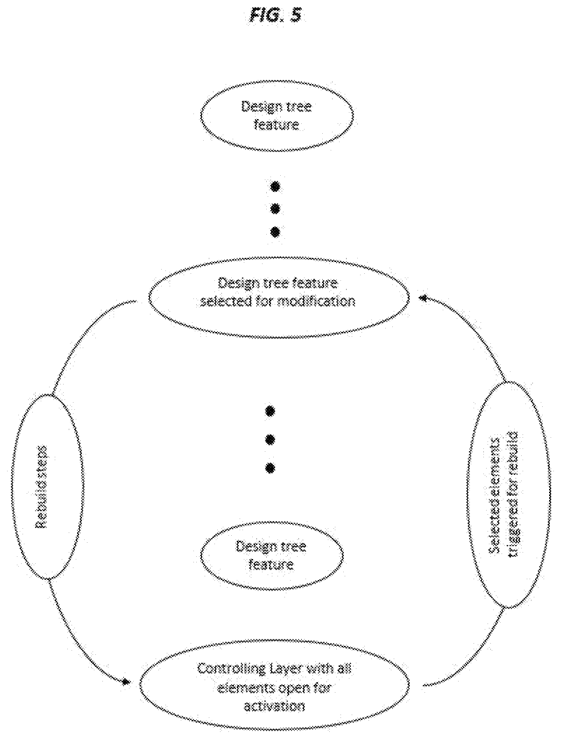

FIG. 4-5. Adaption method functional details, given in examples for 3D parametric model file.

1. Method will allow 3D model developer to perform adapter—application principle “from complex to simple”—to reduce and establish to end users selected for modifications 3D model parameters. Such as: sketches on parts and assembly's levels, features, dimensions, mates within generated for end users transition graphic platform/frame—structured by utilizing graphic's elements of 3D model, with Function of Controlling selected for modifications 3D model design tree parameters, by triggering corresponding for modifications graphic elements of the transition graphic frame. By using adapted for users, simplified controlling tools, with option to be assigned for selected graphic frame elements and parameters to perform 3D models modifications, additional increments of users will be achieved.
Graphic elements of the transition graphic frame/layer within adapter application should cover all parameters selected for modifications on part and assembly level of original 3D model files. What differentiates it from existing parametric software available options, when part parameters on assembly level could be visible and modified in all ranges, and only for selected part, feature within assembly.
Multiple 3D parametric models (assembly level) covered by single transition frame can be described as block, with ability to perform modifications on multiple block's level by utilizing for modifications similar in existing 3D parametric software tools, available on assembly level. But keeping (complex to simple) principle, in order to reduce defined for modifications parameters as mates, features, sketches, dimensions out of all available on block's level. That blocks structure can be exposed in additional levels /files of the transition graphic frame described above.

2. Methods to develop transition application for existing 3D parametric software.

2.1. Standalone (plugin)-Integrated into existing 3D parametric software.
Description: Transition, customized graphic frame within adapter-application can be integrated within 3D parametric programs, and required to have Function of Controlling of any selected parameters in 3D model files of the 3D parametric software, where adaptor-application selected to be nested, such as: sketches, dimensions, features, mates, applications, with purpose to perform/navigate modifications on selected 3D models/files, by establishing connection, between parameters of original 3D models/files selected to be controlled for modifications—and adapted to end user's controlling tools corresponding to these parameters, by utilizing proposed, generated transition graphic frame/layer within adaptor application.

2.2. Existing 3D parametric program's tools extension (add-in).
Description: Current, listed above 3D parametric programs can have new (add-in) adapter-application with an extension to end user's controlling tools interface, and on another end, exposed to custom generated graphic frame/layer applied for 3D model file, to perform customization for selected 3D model/file-simplify, minimize 3D modeling steps, by establishing 3D model parameters to be controlled for modifications and adapted to end user's controlling tools corresponded to these parameters, utilizing generated graphic frame/layer within proposed adaptor (add-in) application.

3. Adapter-application layout options.

3.1. (elementary-with introduction to 3D parametric modeling environment)
Adapter-application end user interface, requires to have controlling tools simplified and/or reduced to minimum, similar to gamer's control panels (control panel's type is optional, TBD). The adaptor-application user's control panel should allow 3D model developers to establish required for 3D model modifications, variable in types and number, controlling tools-available for end users.
Functionality: Allow to perform defined modification on prebuild already 3D parametric models.
Preparations: selected 3D models required adaption to perform modifications, by defining and nesting control parameters within proposed graphic adapter-application.

3.2. (intermediate—with ability of selecting and establishing additional control parameters in 3D modeling environment).
Adapter-application end user interface with controlling tools simplified and/or reduced to minimum, and have in addition to already defined for modifications controlling tools—FLOATING tools, what can be selected within types of the available controlling add-ins tools, in this case additional 3D model modifications can be done out of scope of proposed transition frame.
Functionality: Allow for end user to gain additional control to perform modifications on the 3D parametric model in addition to selected by 3D model developer, parameters of 3D file.
Preparations: selected 3D models required adaption to perform modifications, by defining and nesting control parameters within proposed graphic adapter-application, with providing to end user additional controlling tools, out of scope of controlling parameters selected for 3D model modifications within proposed transition frame/layer.

3.3. (proficient—with ability of controlling all parameters in 3D modeling environment)
Transition from utilization of simplified 3D parametric modeling controlling tools of purposed adapter-application, but having all add-ins tools included, to full version of 3D parametric modeling software control panel.
Functionality: Proposed adapter application has benefit for 3D model developer, in order to expose for modifications, selected 3D model parameters with ability for end user to go beyond established parameters within transition graphic frame, by using all available tools on selected 3D model (gaming as an option).

4. Adaption method functional details examples.

4.1. Example 1. Adaption method functional details for 3D model parametric file/s. (FIG. 4)
One of example of the purposed method can be described as an implementation of an additional controlling frame/layer of graphic and numeric elements, to replicate and represent selected sketches, mates, and corresponding feature parameters for design tree of selected single 3D model/part, with controlling layer at variable/floating position within 3D model design tree structure.
Graphic or numeric elements in original1 controlling layer position (such as sketch/sketches or mate with parameters), when located at the end or within 3D model design tree, should replicate and trigger any selected elements located prior original controlling layer design tree position and be open for activation/modifications with or without specific order (such as initial for modification controlling elements after activation can prompt selected sequential ones and so on).
When active graphic or numeric elements at the level of controlling layer's replication¹ (associated with the feature at the level in the design tree, where command is performed) triggered for activation/modification, these elements go through rebuild step on its level and sequentially activates all corresponding design tree elements located prior original controlling layer, then activates original controlling layer elements to update this layer/rebuild to updated form.
After rebuilt, original controlling layer can be visible instead of its replication with all graphic elements open for activation to perform next selected command, or as an option it can be represented on its replica level at the feature-sketch level/position within design tree, where modification command performed, having visible, open for activation elements represented on this level and non-active other elements—which requires additional step (with some options listed below), to be activated for selected modifications/updates:
Option 1. Trigger² for activation original controlling layer corresponding element-in order to transfer parameters for following modifications, from elements at replica controlling layer position to its corresponding graphic elements on original controlling layer position to generate rebuild/activation steps.
Option 2. Trigger for activation original controlling layer corresponding element, to allow this element to be used in order to enter new parameters for design tree rebuild and go through rebuild/activation steps.
Option 3. Go through rebuild steps as described in this section (4.1), par. 3.
(Provided above non-active elements activation options are not limited, and can be extended).
^{1.} controlling layer can be represented by its replication (replica), located prior original controlling layer position at design tree level of selected for modification feature, so controlling layer replica in its design tree position will be generated when prompted (selected graphic element within design tree structure triggered for modifications by corresponding original layer element) and/or updated when go through activation/rebuild steps, be represented and visible instead of controlling layer in original position, and floating during command's steps.
^{2.} In order to trigger—replicated and corresponding original graphic elements should be linked between each other, non active conditions of the elements will benefit with ability to be used to enter and transfer parameters for following modifications to corresponding active elements in original controlling layer.

4.2. Example 2. Adaption method functional details for 3D model parametric file/s. (FIG. 5)
Second example of the purposed method can be described as an implementation of an additional controlling frame/layer of graphic and numeric elements, to replicate and represent selected sketches, mates, and corresponding feature parameters for design tree of selected single 3D model/part. With controlling layer positioned at the end or within 3D model design tree structure.
Graphic or numeric elements of the controlling layer (such as sketch/sketches or mate with parameters), when located at the end or within 3D model design tree, should replicate and trigger any selected sketch/sketches or mate (as an example) located prior controlling layer design tree position and be open for modifications with or without specific order (such as initial for modification controlling elements after activation can prompt selected sequential ones and so on).
When selected graphic or numeric elements of the controlling layer, triggered for modification command, it activates corresponding elements at the feature-sketch level within design tree and then all sequential associated design tree elements located prior controlling layer position to go through rebuild steps (utilizing existing 3D parametric software commands). After rebuild—controlling layer established in updated form-command performed.
Activated controlling layer graphic elements can be visible during rebuild steps, and visually represented/introduced when rebuild steps are completed.
Adaption methods functional details described in Examples 4.1; 4.2 can be extrapolated for multiple commands performed at once, for additional graphic elements, such as: active and/or non-active, that also can trigger rebuild errors, if selected parameters conflict each other during rebuild.
Controlling layer/ frame examples 4.1; 4.2, given for 3D model/part level can be utilized on upper assembly levels, and be represented on another controlling layer/frame levels associated with 3D assembly file, where models/parts with purposed controlling layers are included, having principles described in claim 1. par. 2-3.

5. Further development:
Developed 3D models/files, created under 3D parametric programs, with utilization of new transition program-application, could have all parameters of the product required for production, as it could be verified by certified, selected manufacturing facilities.
Or
Manufacturing facilities/enterprises could develop own existing product with ability to modify product through customer/user end, by nesting/using introduced above, transition custom graphic frame, within new adaptor-application on own 3D parametric product, what will allow to make changes /editing of these products for allowable scope of modifications, selected by 3D model developer.
